(19) United States
(12) Patent Application Publication
(10) Pub. No.: US 2025/0039289 A1
(43) Pub. Date: Jan. 30, 2025

(54) ELECTRONIC DEVICE INCLUDING HINGE ASSEMBLY

(71) Applicant: Samsung Electronics Co., Ltd., Suwon-si (KR)

(72) Inventor: Jun KIM, Suwon-si (KR)

(21) Appl. No.: 18/785,899

(22) Filed: Jul. 26, 2024

Related U.S. Application Data
(63) Continuation of application No. PCT/KR2024/010973, filed on Jul. 26, 2024.

(30) Foreign Application Priority Data
Jul. 27, 2023 (KR) 10-2023-0098011
Sep. 13, 2023 (KR) 10-2023-0121942

(51) Int. Cl. H04M 1/02

(52) U.S. Cl. CPC H04M 1/0268; H04M 1/022

(57) ABSTRACT

An electronic device is provided. The electronic device includes a first housing, a second housing, a third housing, and a hinge assembly. The hinge assembly includes a first hinge structure rotatably connecting the second housing to the first housing, a second hinge structure rotatably connecting the third housing to the first housing, and a rotation link structure. The rotation link structure may include a first link having one end connected to the first hinge structure, a second link having one end connected to the second hinge structure, and an intermediate link configured to be rotate about a rotation axis. The other end of the first link and the other end of the second link are connected to the intermediate link. In response to the first housing being rotated, the third housing is configured to be rotated according to a movement of the first link and the second link.

### CROSS-REFERENCE TO RELATED APPLICATION(S)

This application is a continuation application, claiming priority under 35 § 365 (c), of an International application No. PCT/KR2024/010973, filed on Jul. 26, 2024, which is based on and claims the benefit of a Korean patent application number 10-2023-0098011, filed on Jul. 27, 2023, in the Korean Intellectual Property Office, and of a Korean patent application number 10-2023-0121942, filed on Sep. 13, 2023, in the Korean Intellectual Property Office, the disclosure of each of which is incorporated by reference herein in its entirety.

### TECHNICAL FIELD

The disclosure relates to an electronic device including a hinge assembly for implementing a multi-foldable structure.

### BACKGROUND ART

With the development of information and communication technology and semiconductor technology, various functions are packed in one portable electronic device. For example, an electronic device may implement not only communication functions but also entertainment functions, such as playing games, multimedia functions, such as playing music and videos, communication and security functions for mobile banking, and scheduling or e-wallet functions. These electronic devices have been downsized to be conveniently carried by users. As mobile communication services spread to multi-media service sectors, there is a rising demand for enlarging the display of the electronic device for convenient use of multi-media services as well as voice calls or text messages. This, however, trades off the trend of electronic devices being compact.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problems

Aspects of the disclosure are to address at least the above-mentioned problems and/or disadvantages and to provide at least the advantages described below. Accordingly, an aspect of the disclosure is to provide an electronic device including a hinge assembly for implementing a multi-foldable structure.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing, a third housing, and a hinge assembly. The hinge assembly includes a first hinge structure rotatably connecting the second housing to the first housing, a second hinge structure rotatably connecting the third housing to the first housing, and a rotation link structure. The rotation link structure includes a first link 261 having one end connected to the first hinge structure, a second link 262 having one end connected to the second hinge structure, and an intermediate link 263 configured to rotate about a rotation axis. The other end of the first link and the other end of the second link are connected to the intermediate link. In response to the first housing being rotated, the third housing is configured to be rotated according to a movement of the first link and the second link.

In accordance with another aspect of the disclosure, an electronic device is provided. The electronic device includes a first housing, a second housing, a third housing, and a hinge assembly. The hinge assembly includes a first hinge structure rotatably connecting the second housing to the first housing, a second hinge structure rotatably connecting the third housing to the first housing, and a rotation link structure. The rotation link structure may include a first link 261 having one end connected to the first hinge structure, a second link 262 having one end connected to the second hinge structure, and an intermediate link 263 configured to rotate about a rotation axis. When the first housing is rotated, the first link and the second link of the rotation link structure are configured to be rotated to rotate the third housing. The hinge assembly may be configured such that when an inclination angle of the second housing with respect to the first housing becomes greater than a first designated angle (α1) while the second housing rotates, the third housing starts to rotate based on the rotation of the second housing.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device in an unfolded state according to an embodiment of the disclosure;

FIG. 3 is a rear perspective view illustrating an electronic device in an unfolded state according to an embodiment of the disclosure;

FIG. 4 is a perspective view illustrating an electronic device in a folded state according to an embodiment of the disclosure;

FIG. 5 is a perspective view illustrating an electronic device illustrating a hinge assembly according to an embodiment of the disclosure;

FIG. 6 is an enlarged view of part A of FIG. 5 according to an embodiment of the disclosure;

FIG. 7A is a side view illustrating an electronic device in a folded state according to an embodiment of the disclosure;

FIG. 7B is an enlarged view illustrating a first hinge structure and a rotation link structure of an electronic device according to an embodiment of the disclosure;

FIG. 8 is a view illustrating a rotation operation of a housing of an electronic device according to an embodiment of the disclosure;

FIGS. 9A, 9B, 9C, 9D, 9E, and 9F are side views illustrating an electronic device in an intermediate state according to various embodiments of the disclosure;

FIG. 9G is a side view illustrating an electronic device in a folded state according to an embodiment of the disclosure;

FIG. 10 is a perspective view illustrating an electronic device according to an embodiment of the disclosure;

FIG. 11 is a perspective view illustrating a hinge assembly of an electronic device according to an embodiment of the disclosure; and

FIG. 12 is a side view illustrating an electronic device in a folded state according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the spirit or scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

As used herein, the singular forms “a,” “an,” and “the” are intended to include the plural forms as well, unless the context clearly indicates otherwise. For example, the phrase “surface of a component” may refer to one or more of surfaces of the component.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

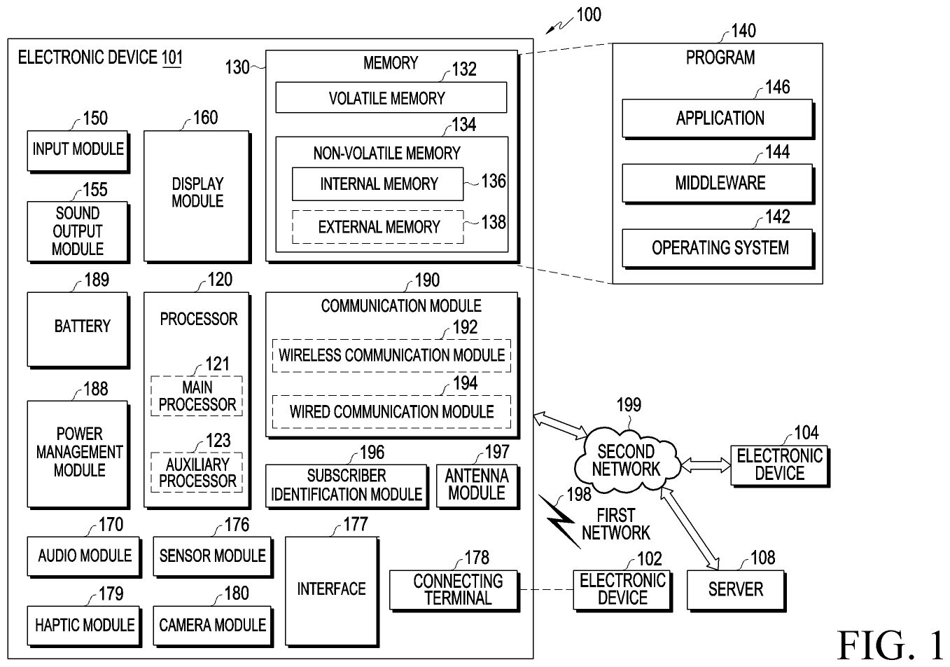

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, a length direction, a width direction, and/or a thickness direction of the electronic device may be mentioned and may be defined as a ‘Y-axis direction,’ ‘X-axis direction’, and/or ‘Z-axis direction,’ respectively. In an embodiment, ‘negative/positive (−/+)’ may be mentioned together with the Cartesian coordinate system exemplified in the drawings with respect to the direction in which the component is oriented. For example, the front surface of the electronic device or housing may be defined as a ‘surface facing in the +Z direction,’ and the rear surface may be defined as a ‘surface facing in the −Z direction’. In an embodiment, the side surface of the electronic device or housing may include an area facing in the +X direction, an area facing in the +Y direction, an area facing in the −X direction, and/or an area facing in the −Y direction. In another embodiment, the ‘X-axis direction’ may mean including both the ‘−X direction’ and the ‘+X direction’. It should be noted that the directions are so defined with respect to the Cartesian coordinate system shown in the drawings for the sake of brevity of description, and the description of these directions or components do not limit an embodiment of the disclosure. For example, the direction in which the front surface or rear surface faces may be varied depending on the unfolded state or folded state of the electronic device, and the above-mentioned directions may be interpreted as different ones depending on the user's way to grip.

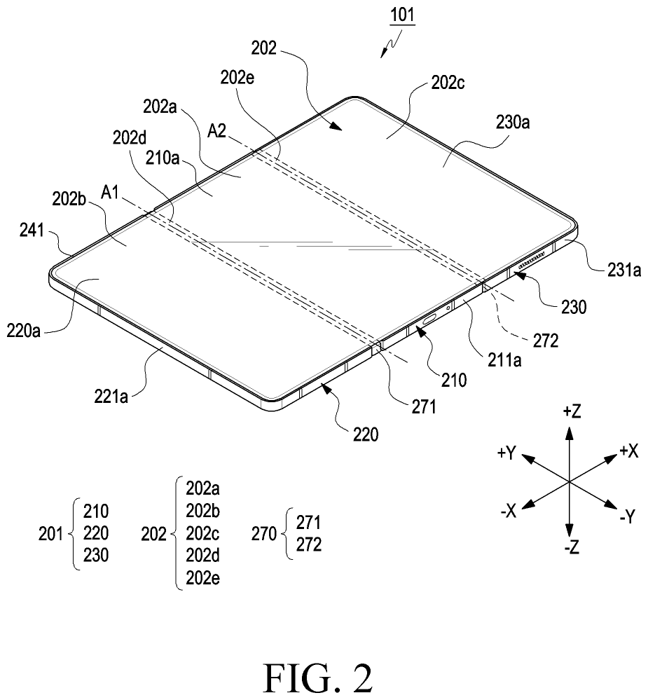

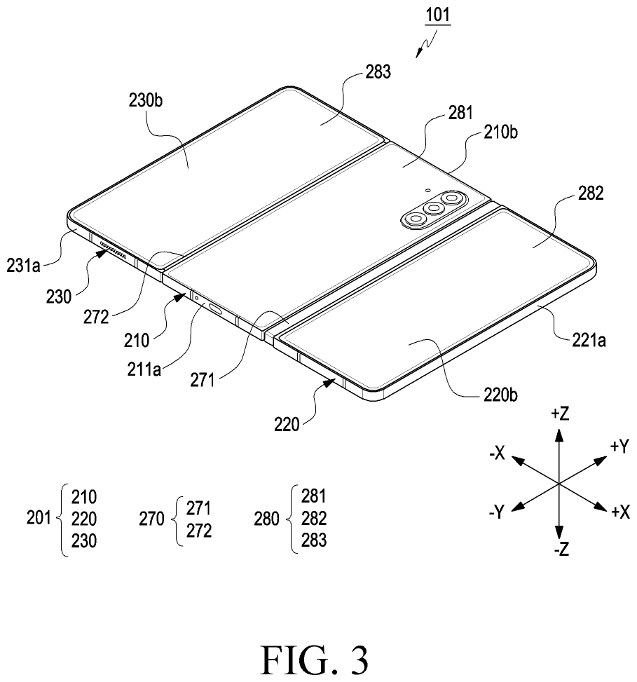

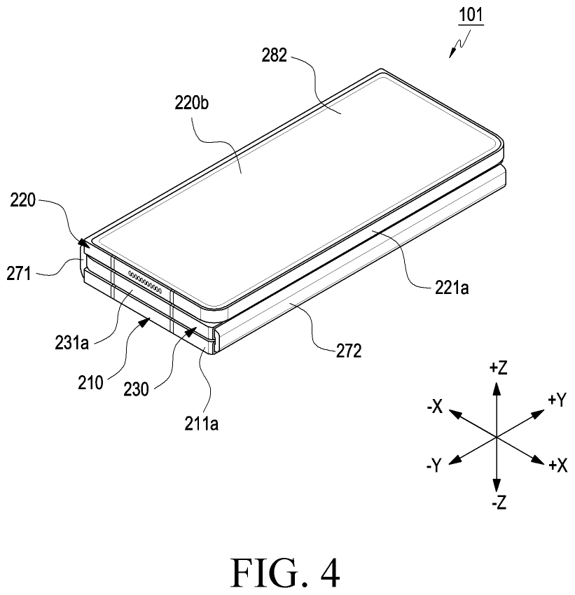

FIG. 2 is a front perspective view illustrating an electronic device in an unfolded state according to an embodiment of the disclosure. FIG. 3 is a rear perspective view illustrating an electronic device in an unfolded state according to an embodiment of the disclosure. FIG. 4 is a perspective view illustrating an electronic device in a folded state according to an embodiment of the disclosure. The configuration of the electronic device 101 of FIGS. 2 and 3 may be identical in whole or part to the configuration of the electronic device 101 of FIG. 1.

FIGS. 2 and 3 are views illustrating an unfolded state of an electronic device according to various embodiments of the disclosure. FIG. 4 is a view illustrating a folded state of an electronic device according to an embodiment of the disclosure.

Referring to FIGS. 2 and 3, in an embodiment, an electronic device 101 may include a housing 201, a hinge cover 270 covering a foldable portion of the housing 201, and a flexible or foldable display 202 (hereinafter, simply “display 202”) disposed in a space formed by the housing 201. According to an embodiment, the surface on which the display 202 is disposed is defined as a front surface (e.g., the first front surface 210a, the second front surface 220a, and the third front surface 230a) of the electronic device 101. A surface opposite to the front surface is defined as a rear surface (e.g., the first rear surface 210b, the second rear surface 220b, and the third rear surface 230b) of the electronic device 101. A surface surrounding the space between the front and rear surfaces is defined as a side surface (e.g., the first side surface 211a, the second side surface 221a, and the third side surface 231a) of the electronic device 101.

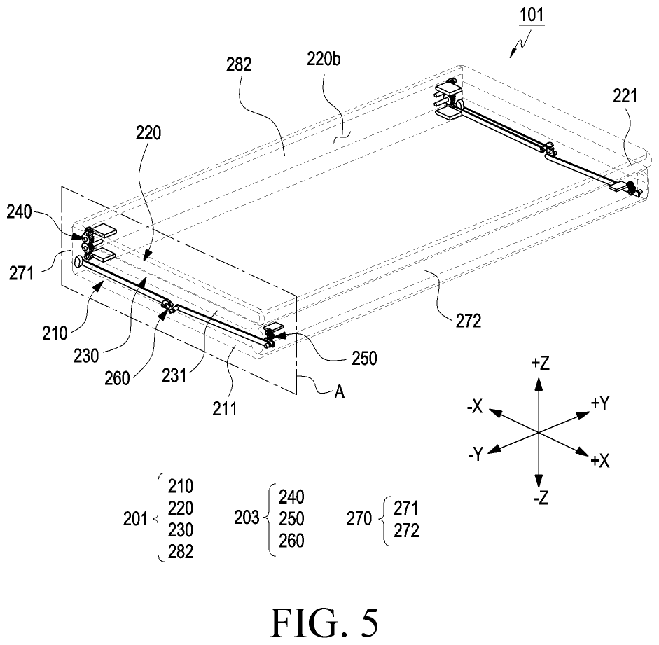

According to an embodiment, the housing 201 may include a first housing 210, a second housing 220 rotatably or pivotably coupled to one side (e.g., the −X direction side) of the first housing 210, a third housing 230 rotatably or pivotably coupled to an opposite side (e.g., the +X direction side) of the first housing 210, and a rear cover 280. According to an embodiment, the rear cover 280 may include a first rear cover 281 disposed on the first rear surface 210b, a second rear cover 282 disposed on the second rear surface 220b, and a third rear cover 283 disposed on the third rear surface 230b. According to an embodiment, a hinge assembly (e.g., the hinge assembly 203 of FIG. 5) may be disposed in the housing 201. The hinge assembly 203 may provide a first folding axis A1 which is the center of rotation of the second housing 220 with respect to the first housing 210 and a second folding axis A2 which is the center of rotation of the third housing 230 with respect to the first housing 210. The housing 201 of the electronic device 101 is not limited to the shape and coupling illustrated in FIGS. 2 to 4, and may be implemented by a combination and/or coupling of other shapes or components. For example, in an embodiment, the first housing 210 and the first rear cover 281 may be integrally formed, the second housing 220 and the second rear cover 282 may be integrally formed, and the third housing 230 and the third rear cover 283 may be integrally formed.

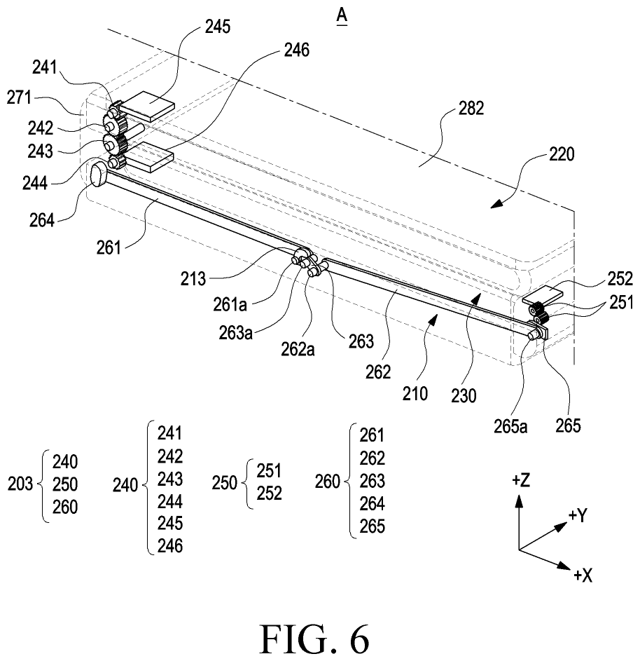

According to an embodiment, the first housing 210 may be connected to a hinge structure (e.g., the first hinge structure 240 and the second hinge structure 250 of FIG. 5) and may include a first front surface 210a facing in a first direction and a first rear surface 210b facing in a second direction opposite to the first direction. The second housing 220 may be connected to a hinge structure (e.g., the first hinge structure 240 of FIG. 5) and may include a second front surface 220a facing in a third direction and a second rear surface 220b facing in a fourth direction opposite to the third direction. The second housing 220 may rotate about the first hinge structure 240 with respect to the first housing 210. The third housing 230 may be connected to a hinge structure (e.g., the second hinge structure 250 of FIGS. 5 and 6), and may include a third front surface 230a facing in a fifth direction and a third rear surface 230b facing in a sixth direction opposite to the fifth direction. The third housing 230 may rotate about the second hinge structure 250 with respect to the first housing 210. Thus, the electronic device 101 may turn into a folded state or unfolded state. In the folded state of the electronic device 101, the third housing 230 may be positioned between the first housing 210 and the second housing 220. In the folded state of the electronic device 101, the first front surface 210a may face the third front surface 230a, and the second front surface 220a may face the third rear surface 230b. In the unfolded state of the electronic device 101, the first direction, the third direction, and the fifth direction may be substantially parallel to each other. Hereinafter, unless otherwise mentioned, directions are described based on the unfolded state of the electronic device 101.

As is described below, the angle or distance between the first housing 210, the second housing 220, and the third housing 230 may vary depending on whether the electronic device 101 is in the unfolded state, the folded state, or the intermediate state. In an embodiment, the folding axes A1 and A2 are provided along the length direction (Y-axis direction) of the electronic device 101, but the direction of the folding axes A1 and A2 is not limited thereto. For example, it may be understood that the electronic device 101 includes the folding axes A1 and A2 extending along the width direction (e.g., the X-axis direction) according to the external design or the user's usage habit.

According to an embodiment, the electronic device 101 may further include a structure in which a digital pen may be inserted. For example, a hole into which the digital pen may be inserted may be formed in the side surface of the second housing 220 or the side surface of the third housing 230 of the electronic device 101.

According to an embodiment, at least a portion of the first housing 210, the second housing 220, and the third housing 230 may be formed of a metallic material or a nonmetallic material having rigidity of a size selected to support the display 202. At least a portion formed of the metallic material may provide a ground plane of the electronic device 101, and may be electrically connected to a ground conductor provided on a printed circuit board of the electronic device 101 disposed in the housing 201.

According to an embodiment, the first rear cover 281 may be disposed on one side (e.g., the −X direction side) of the first folding axis A1 on the rear surface of the electronic device 101, and may have, e.g., a substantially rectangular periphery, and the periphery may be surrounded by the first housing 210. Similarly, the second rear cover 282 may be disposed on the other side (e.g., the +X direction side) of the first folding axis A1 of the rear surface of the electronic device 101, and the periphery thereof may be surrounded by the second housing 220. The third rear cover 283 may be disposed on one side of the second folding axis A2 of the rear surface of the electronic device 101, and the periphery thereof may be surrounded by the third housing 230. In an embodiment, the electronic device 101 may include a first rear cover 281, a second rear cover 282, and a third rear cover 283 of various shapes.

According to an embodiment, the housing 201 may form a space in which various components (e.g., a printed circuit board or a battery) of the electronic device 101 may be disposed. According to an embodiment, one or more components may be arranged or visually exposed on/through the rear surface of the electronic device 101. For example, in an embodiment, at least a portion of the sub-display may be visually exposed through at least a partial area of the second rear cover 282. For example, the second rear cover 282 may be replaced with a display and a cover plate for protecting the display. For example, one or more components or sensors may be visually exposed through a partial area of the second rear cover 282. In an embodiment, the sensor may include a proximity sensor and/or a camera device.

Referring to FIG. 3, the hinge cover 270 may include a first hinge cover 271 disposed between the first housing 210 and the second housing 220 and a second hinge cover 272 disposed between the first housing 210 and the third housing 230. The hinge cover 270 may be configured to cover internal components (e.g., the first hinge structure 240 and the second hinge structure 250 of FIG. 5). According to an embodiment, the first hinge cover 271 and/or the second hinge cover 272 may be covered by a portion of the first housing 210, the second housing 220, and the third housing 230 or may be exposed to the outside depending on a state (e.g., a flat state or a folded state) of the electronic device 101. For example, in the unfolded state, the hinge cover 270 may be substantially covered by the first housing 210, the second housing 220, and/or the third housing 230, and in the folded state (see FIG. 4), most of the outer surface of the second hinge cover 272 may be visually exposed to the outside.

For example, as illustrated in FIGS. 2 and 3, when the electronic device 101 is in the unfolded state, a portion of the second hinge cover 272 may be covered by the first housing 210 and the second housing 220 so as not to be exposed. When the electronic device 101 is in the unfolded state, the whole or portion of the second hinge cover 272 may be covered by the first housing 210 and the third housing 230 so as not to be exposed. As another example, as illustrated in FIG. 4, when the electronic device 101 is in the folded state (e.g., the fully folded state), the first hinge cover 271 and the second hinge cover 272 may be visually exposed to the outside of the electronic device 101. As another example, in the intermediate state in which the second housing 220 and/or the third housing 230 are folded with a certain angle with respect to the first housing 210, a portion of the first hinge cover 271 and/or the second hinge cover 272 may be visually exposed between the first housing 210 and the second housing 220 or between the first housing 210 and the third housing 230. In this case, the exposed area may be smaller than when the electronic device 101 is in the fully folded state. In an embodiment, the first hinge cover 271 and/or the second hinge cover 272 may include a curved surface.

According to an embodiment, the display 202 may be disposed in a space formed by the housing 201. For example, the display 202 may be seated on a recess formed by the housing 201 and may occupy most of the front surface of the electronic device 101. Accordingly, the front surface of the electronic device 101 may include the display 202 and a partial area of the first housing 210, a partial area of the second housing 220, and a partial area of the third housing 230, which are adjacent to the display 202. The rear surface of the electronic device 101 may include the first rear cover 281 and a partial area of the first housing 210 adjacent to the first rear cover 281, the second rear cover 282 and a partial area of the second housing 220 adjacent to the second rear cover 282, the third rear cover 283 and a partial area of the third housing 230 adjacent to the third rear cover 283.

According to an embodiment, the display 202 may mean a display at least a portion of which may be transformed into a flat or curved surface. According to an embodiment, the display 202 may include folding areas 202d and 202e, a first display area 202a disposed on one side (e.g., the left side or −X direction of the first folding area 202d illustrated in FIG. 2) with respect to the first folding area 202d, a second display area 202b disposed between the first folding area 202d and the second folding area 202e, and a third display area 202c disposed on one side (e.g., the right side or +X direction of the first folding area 202d illustrated in FIG. 2) with respect to the second folding area 202e.

However, the area division of the display 202 according to an embodiment disclosed herein is exemplary, and the display 202 may be divided into four or more areas according to the structure or function. For example, according to the embodiment illustrated in FIG. 2, the areas of the display 202 may be divided by the folding areas 202d and 202e extending along one axis (e.g., the Y axis) or the folding axes A1 and A2. In an embodiment, the display 202 may be divided into areas based on another folding area (e.g., a folding area parallel to the X-axis) or another folding axis (e.g., a folding axis parallel to the X-axis). According to an embodiment, the display 202 may be coupled with or disposed adjacent to a touch detection circuit, a pressure sensor capable of measuring the strength (pressure) of touches, and/or a digitizer (not shown) for detecting a magnetic field-type stylus pen.

Hereinafter, the operations of the first housing 210, the second housing 220, and the third housing 230 and the areas of the display 202 according to the states (e.g., the flat state or the unfolded state and the folded state) of the electronic device 101 are described.

According to an embodiment, when the electronic device 101 is in the flat state (e.g., FIGS. 2 and 3) (or the open state), the first housing 210, the second housing 220, and the third housing 230 may form an angle of substantially about 180 degrees with respect to each other, and the first display area 202a, the second display area 202b, and the third display area 202c may be disposed to face in substantially the same direction. For example, in the unfolded state, the surface of the first display area 202a and the surface of the second display area 202b may form substantially about 180 degrees with each other, and may face in the same direction (e.g., the front direction of the electronic device). The folding areas 202d and 202e may form substantially the same plane as the first display area 202a, the second display area 202b, and the third display area 202c.

According to an embodiment, when the electronic device 101 is in the folded state (e.g., FIG. 4) (or the closed state), the first housing 210, the second housing 220, and the third housing 230 may be disposed to face each other. In the folded state of the electronic device 101, the third housing 230 may be disposed between the first housing 210 and the second housing 220. The surface of the first display area 202a of the display 202 and the surface of the third display area 202c may form a narrow angle (e.g., between 0 degrees and about 10 degrees) with each other and may substantially face each other. The surface of the second display area 202b of the display 202 and the surface of the third rear cover 283 may form a narrow angle (e.g., between 0 degrees and about 10 degrees) with each other and may substantially face each other. At least a portion of the folding areas 202d and 202e may be a curved surface having a predetermined curvature.

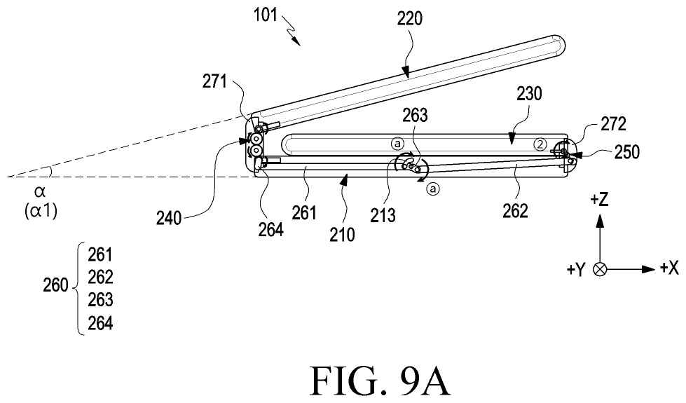

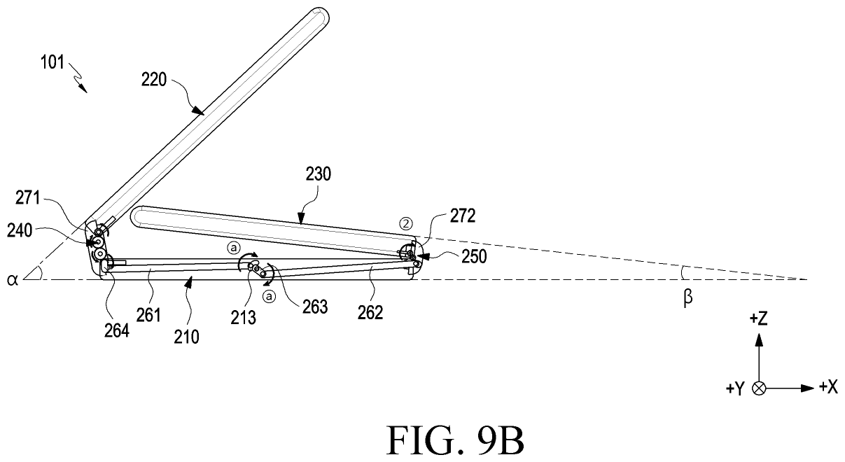

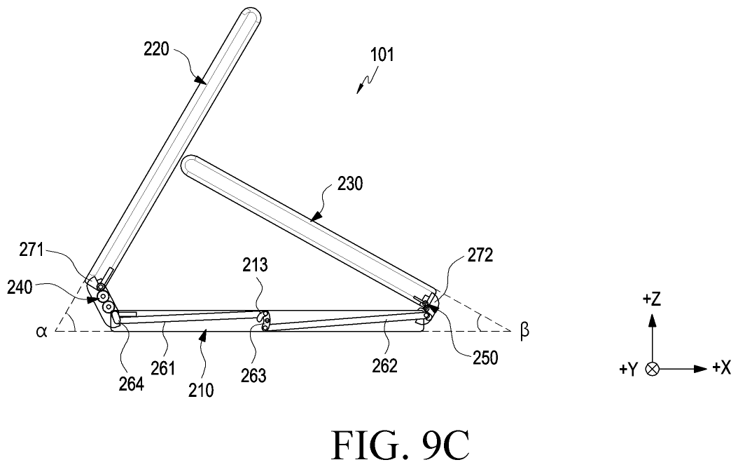

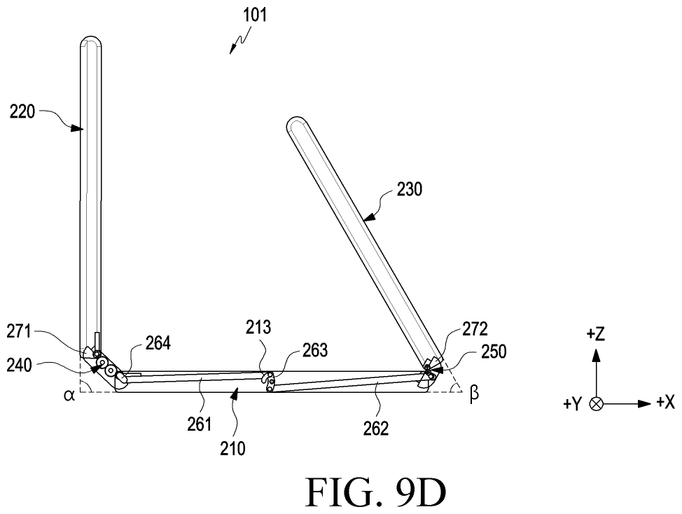

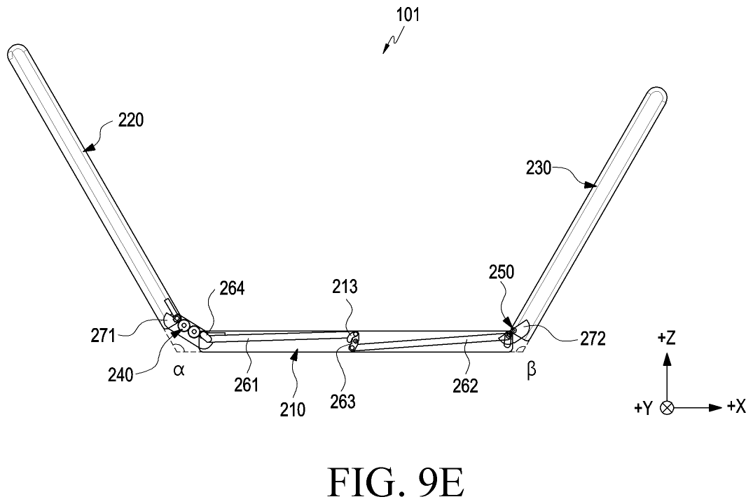

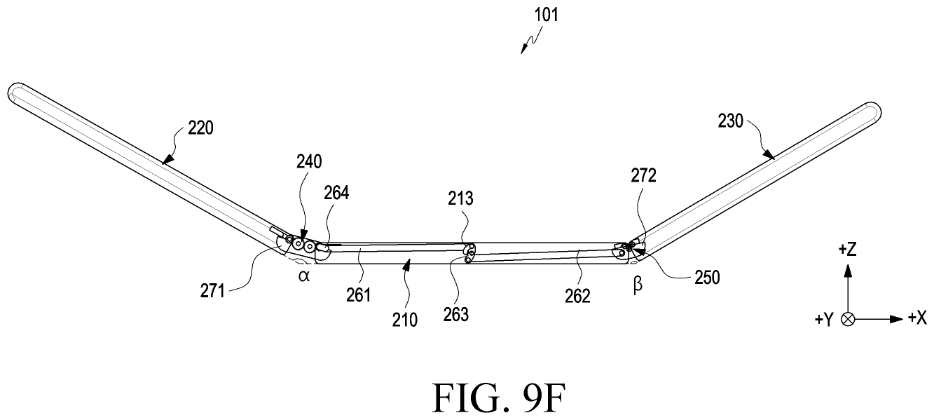

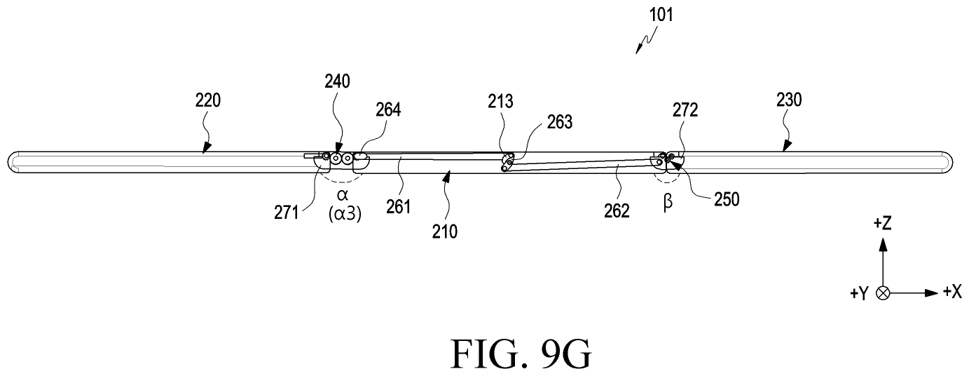

According to an embodiment, when the electronic device 101 is in an intermediate state (see FIGS. 9B to 9G), the second housing 220 and/or the third housing 230 may be disposed at a certain angle with respect to the first housing 210. The surface of the first display area 202a and the surface of the second display area 202b of the display 202 may form an angle larger than that in the folded state and smaller than that in the unfolded state. The surface of the first display area 202a and the surface of the third display area 202c of the display 202 may form an angle larger than that in the folded state and smaller than that in the unfolded state. At least a portion of the folding areas 202d and 202e may be formed of a curved surface having a predetermined curvature, and the curvature in this case may be smaller than that in the folded state.

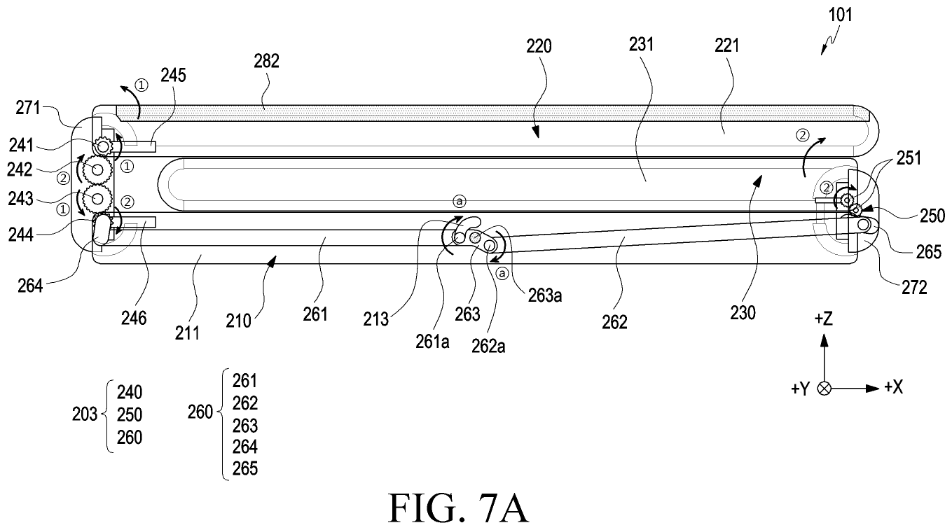

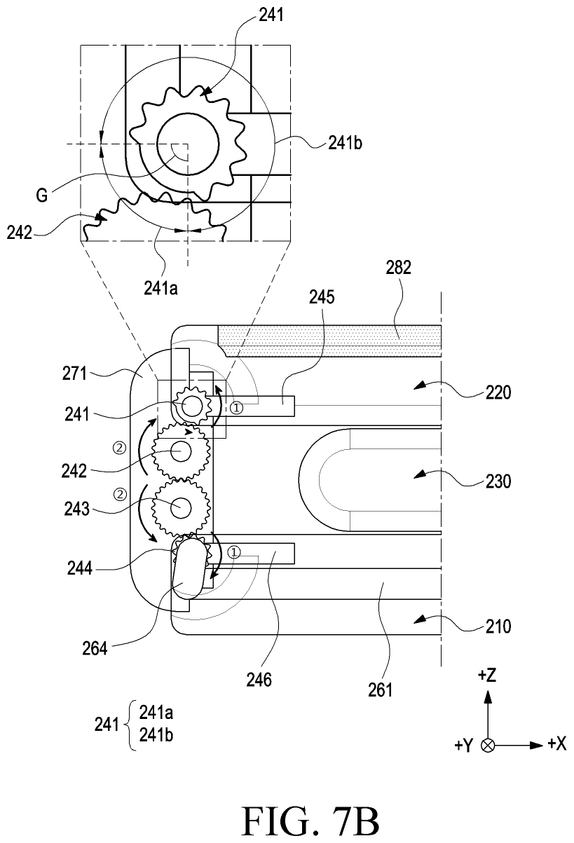

FIG. 5 is a perspective view illustrating an electronic device illustrating a hinge assembly according to an embodiment of the disclosure. FIG. 6 is an enlarged view of part A of FIG. 5 according to an embodiment of the disclosure. FIG. 7A is a side view illustrating an electronic device in a folded state according to an embodiment of the disclosure. FIG. 7B is an enlarged view illustrating a first hinge structure and a rotation link structure of an electronic device according to an embodiment of the disclosure.

The configuration of the electronic device 101 of FIG. 5 may be identical or similar in whole or part to the configuration of the electronic device 101 of FIGS. 1 to 4. The housing 201 and the hinge cover 270 of the embodiments of FIGS. 5, 6, 7A, 7B, and 8 may be referred to as the housing 201 and the hinge cover 270 of the embodiments of FIGS. 2 to 4. Hereinafter, the component of the same reference numeral as the component of FIGS. 5, 6, 7A, 7B, and 8 will not be described in duplicate with reference to FIGS. 2 to 4.

FIGS. 5, 6, 7A, and 7B may illustrate the electronic device 101 in the folded state (e.g., FIG. 4). Referring to FIG. 5, in an embodiment, the electronic device 101 may include a housing 201, a hinge assembly 203, and a hinge cover 270.

According to an embodiment, the housing 201 may include a first housing 210, a second housing 220, and a third housing 230. The second housing 220 may be rotatably connected to one side (e.g., a left side or a −X direction side with respect to the first housing 210 of FIG. 5) of the first housing 210. The third housing 230 may be rotatably connected to the other side of the first housing 210 (e.g., the left side or the +X direction side with respect to the first housing 210 of FIG. 5).

According to an embodiment, the first housing 210 may include a first side structure 211 forming a side surface (e.g., the first side surface 211a of FIGS. 2 to 4) of the electronic device 101. The second housing 220 may include a second side structure 221 forming a side surface (e.g., the second side surface 221a of FIGS. 2 to 4) of the electronic device 101. The third housing 230 may include a third side structure 231 forming a side surface (e.g., the third side surface 231a of FIGS. 2 to 4) of the electronic device 101. According to an embodiment, the housing 201 may include a first rear cover 281, a second rear cover (e.g., the second rear cover 282 of FIG. 3), and a third rear cover (e.g., the third rear cover 283 of FIG. 3). The housing 201 of the electronic device 101 is not limited to the shape and coupling illustrated in FIGS. 5, 6, 7A, 7B, and 8, and may be implemented by a combination and/or coupling of other shapes or components.

According to an embodiment, the housing 201 may form a space in which various components (e.g., the hinge structures 240 and 250) of the electronic device 101 may be disposed. According to an embodiment, one or more components may be disposed on the rear surface of the electronic device 101 or may be visually exposed. For example, at least a portion of the sub display may be visually exposed through at least a partial area of the second rear cover 282.

According to an embodiment, the second housing 220 may rotate about a hinge structure (e.g., the first hinge structure 240) with respect to the first housing 210. The third housing 230 may rotate about the hinge structure (e.g., the second hinge structure 250) with respect to the first housing 210. Thus, the electronic device 101 may turn into a folded state or unfolded state. According to an embodiment, in the folded state (see FIGS. 4 and 5) of the electronic device 101, the third housing 230 may be positioned between the first housing 210 and the second housing 220. According to an embodiment, in the unfolded state (see FIGS. 2, 3, and 9H) of the electronic device 101, the first housing 210 may be disposed between the second housing 220 and the third housing 230.

In an embodiment, the electronic device 101 may include a flexible or foldable display (e.g., the display 202 of FIG. 2) disposed in a space formed by the housing 201. According to an embodiment, a surface on which the display 202 is disposed is defined as a front surface (e.g., the first front surface 210a, the second front surface 220a, and the third front surface 230a) of the electronic device 101. In the folded state of the electronic device 101, the front surface (e.g., the first front surface 210a of FIG. 1) of the first housing 210 and the front surface (e.g., the third front surface 230a of FIG. 2) of the third housing may face each other, and the front surface (e.g., the second front surface 220a of FIG. 2) of the second housing 220 may face the front surface (e.g., the third rear surface 230b of FIG. 2) of the third housing. In the state in which the electronic device 101 is unfolded, the front surface (e.g., the first front surface 210a of FIG. 1) of the first housing 210, the front surface (e.g., the second front surface 220a of FIG. 2) of the second housing 220, and the front surface (e.g., the third front surface 230a of FIG. 2) of the third housing may face in substantially the same direction and/or may be disposed on substantially the same plane.

In an embodiment, the hinge assembly 203 may include a first hinge structure 240 rotatably connecting the second housing 220 to the first housing 210, a second hinge structure 250 rotatably connecting the third housing 230 to the first housing 210, and a rotation link structure 260 configured to enable interworking of rotation or pivot of the first hinge structure 240 and the second hinge structure 250.

According to an embodiment, the hinge assembly 203 may provide a folding axis (e.g., the first folding axis A1 of FIG. 2) serving as the center of rotation of the second housing 220 with respect to the first housing 210 and a folding axis (e.g., the second folding axis A2 of FIG. 2) serving as the center of rotation of the third housing 230 with respect to the first housing 210. According to an embodiment, when the second housing 220 is rotated on the folding axis with respect to the first housing 210, the first hinge structure 240 fixedly connected to the second housing 220 may be rotated, and the rotation link structure 260 may interwork the rotation of the first hinge structure 240 with the rotation of the second hinge structure 250. When the second hinge structure 250 is rotated, the third housing 230 fixedly connected to the second hinge structure 250 may be rotated. In the disclosure, the rotation of the first hinge structure 240 or the second hinge structure 250 may mean that at least one gear constituting the first hinge structure 240 or the second hinge structure 250 is rotated.

Referring to FIGS. 6, 7A, and 7B, according to an embodiment, the first hinge structure 240 may include a first gear 241, a second gear 242, a third gear 243, a fourth gear 244, a first fixing member 245, and a second fixing member 246. According to an embodiment, the first fixing member 245 may be fixedly connected to the second housing 220. The first gear 241 may be rotatably connected to the first fixing member 245. For example, the first fixing member 245 may include a shaft portion that is a rotation center of the first gear 241. According to an embodiment, the second fixing member 246 may be fixedly connected to the first housing 210. The fourth gear 244 may be rotatably connected to the second fixing member 246. For example, the second fixing member 246 may include a shaft portion that is a rotation center of the fourth gear 244. The second gear 242 may be disposed between the first gear 241 and the third gear 243 and may be meshed with the first gear 241 and the third gear 243. The third gear 243 may be disposed between the second gear 242 and the fourth gear 244 and may be meshed with the second gear 242 and the fourth gear 244. According to an embodiment, when the second housing 220 is rotated, the rotational force of the second housing 220 may be sequentially transferred to the third housing 230 via the first hinge structure 240, the rotation link structure 260, and the second hinge structure 250, and the third housing 230 may be rotated in a direction (e.g., clockwise with reference to FIG. 6) opposite to the rotational direction (e.g., counterclockwise with reference to FIG. 6) of the first housing 210, and vice versa. For example, the rotational force of the first gear 241 based on the rotation of the second housing 220 may be sequentially transferred to the rotation link structure 260 through the second gear 242, the third gear 243, and the fourth gear 244. According to an embodiment, the size of the teeth of the second gear 242 and the third gear 243 may be smaller than the size of the teeth of the first gear 241 and the fourth gear 244, and the number of the teeth of the second gear 242 and the third gear 243 may be larger than the number of the teeth of the first gear 241 and the fourth gear 244. For example, the third gear 243 may be substantially the same as the second gear 242. For example, the fourth gear 244 may be substantially the same as the first gear 241.

Referring to FIG. 7B, the first gear 241 may include a first gear area 241a in which no teeth are formed and a second gear area 241b in which teeth are formed. The first gear area 241a may be narrower than the second gear area 241b. For example, the angle (the angle G of FIG. 7B) at which the first gear area 241a is formed may be about 37 degrees to about 50 degrees or about 44 degrees to about 47 degrees, and may be, e.g., about 45 degrees. When the electronic device 101 rotates the second housing 220 with respect to the first housing 210 in a range larger than 0 and less than or equal to a first designated angle from the closed state, the second gear 242 may face the first gear area 241a of the first gear 241. In a state in which the first gear area 241a of the first gear 241 faces the second gear 242, the first gear area 241a may be finely spaced apart from the teeth of the second gear 242. Accordingly, when the electronic device 101 rotates the second housing 220 in a range larger than 0 and less than or equal to the first designated angle with respect to the first housing 210 from the closed state, the second gear 242 may remain stationary (see FIG. 9B). When the electronic device 101 rotates the second housing 220 by an angle larger than the first designated angle from the closed state, the second gear 242 may be meshed with teeth of the second gear area 241b of the first gear 241, and may be rotated based on the rotational force of the first gear 241. The first designated angle may be about 20 degrees to about 40 degrees or about 25 degrees to about 35 degrees, and may be, e.g., about 30 degrees.

Referring to FIGS. 6 and 7A, according to an embodiment, a gear array 251 and a third fixing member 252 may be included. According to an embodiment, the third fixing member 252 may be fixedly connected to the third housing 230, and the gear array 251 may be rotatably connected to the third fixing member 252. The third fixing member 252 may include a shaft portion of the gear array 251 that is a rotation center of a gear connected to the third fixing member 252. For example, the gear array 251 may include a plurality (e.g., three) gears arranged in one row. For example, the number of the plurality of gears constituting the gear array 251 may be odd. For example, the plurality of gears constituting the gear array 251 of the second hinge structure 250 may be smaller in tooth size, and may have more teeth, than the first gear 241 and the fourth gear 244 of the first hinge structure 240. For example, the plurality of gears constituting the gear array 251 may be substantially the same as each other.

In an embodiment, the electronic device 101 may include a hinge cover 270 that forms a portion of the external appearance. The hinge cover 270 may include a first hinge cover 271 (e.g., the first hinge cover 271 of FIGS. 2 to 4) surrounding at least a portion of the first hinge structure 240 and a second hinge cover 272 (e.g., the second hinge cover 272 of FIGS. 2 to 4) surrounding at least a portion of the second hinge structure 250. For example, the first hinge structure 240 may be disposed in a space formed of the first housing 210, the second housing 220, and the first hinge cover 271. For example, the second hinge structure 250 may be disposed in a space formed of the first housing 210, the third housing 230, and the second hinge cover 272. In the disclosure, the shapes of the first hinge cover 271 and the second hinge cover 272 may be changed. For example, in FIG. 7B, a portion of the first hinge cover 271 surrounding the first hinge structure 240 may be omitted, and the first hinge cover 271 may be configured so that an internal component (e.g., the first hinge structure 240) is not visually exposed to the outside of the electronic device 101 (see FIG. 9A)). According to an embodiment, the first connection link 264 of the rotation link structure 260, which is described below, may be fixedly connected to the first hinge cover 271.

In an embodiment, the rotation link structure 260 may be configured to interwork the rotation of the second housing 220 with the rotation of the third housing 230 or the rotation of the first hinge structure 240 or the rotation of the second hinge structure 250 with respect to the first housing 210. Referring to FIG. 6, in an embodiment, the rotation link structure 260 may include a first link 261 connected to the first hinge structure 240, a second link 262 connected to the second hinge structure 250, an intermediate link 263 connecting the first link 261 and the second link 262, a first connection link 264 connecting the first link 261 to the first hinge structure 240 (e.g., the fourth gear 244), and a second connection link 265 (including fourth link shaft 265a) connecting the second link 262 to the second hinge structure 250 (e.g., the gear array 251). According to an embodiment, the rotation link structure 260 may include a first link shaft 261a rotatably connected to the first link 261 and the intermediate link 263, a second link shaft 262a rotatably connected to the second link 262 and the intermediate link 263, and a third link shaft 263a serving as a center of rotation of the intermediate link 263. For example, the first link 261 may be rotatably connected to the first link shaft 261a, and the second link 262 may be rotatably connected to the second link shaft 262a. For example, the intermediate link 263 may be rotatably connected to the third link shaft 263a.

In an embodiment, the intermediate link 263 may be configured to be rotatable in a predetermined angular range about the rotation axis provided by the third link shaft 263a. In an embodiment, the first housing 210 may include a guide recess 213 in which a portion of the first link shaft 261a is received. The guide recess 213 may limit the rotation angle of the intermediate link 263. For example, the range of the rotation angle of the intermediate link 263 may be about 30 degrees to about 60 degrees or about 40 degrees to about 50 degrees, and may be, e.g., about 45 degrees. According to an embodiment, with reference to FIG. 6, when the second housing 220 is rotated to be unfolded with respect to the first housing 210, the first link 261 may be moved toward the second hinge structure 250, and the first link shaft 261a may be moved along the guide recess 213, so that the intermediate link 263 may be rotated clockwise, and the second link 262 may be moved toward the first hinge structure 240 and the third housing 230 may be rotated to be unfolded with respect to the first housing 210.

In an embodiment, the rotation link structure 260 may be configured to rotate the second housing 220 faster than the first housing 210 when the angle formed by the second housing 220 with respect to the first housing 210 is within a specific angular range. According to an embodiment, the intermediate link 263 may be formed so that the first link 261 and the second link 262 are not parallel to each other in the folded state of the electronic device 101. For example, the intermediate link 263 may have a shape such as ‘^{Λ}’. According to an embodiment, the intermediate link 263 may be formed so that the first link shaft 261a is positioned at a height (e.g., Z-axis height) identical or similar to the third link shaft 263a, and the second link shaft 262a is positioned at a height (e.g., Z-axis height) lower than the first link shaft 261a and the third link shaft 263a. In other words, the third link shaft 263a and the first link shaft 261a may be disposed to the same or a similar distance from the rear surface (e.g., the −Z direction surface or the second rear surface 220b of FIG. 3) of the first housing 210, and the second link shaft 262a may be disposed closer to the rear surface of the first housing 210 than the first link shaft 261a and the third link shaft 263a.

Hereinafter, operations of the second housing 220, the third housing 230, the first hinge structure 240, the second hinge structure 250, and the rotation link structure 260 when the electronic device 101 is changed from the folded state to the unfolded state are described with reference to FIGS. 7A and 7B. For example, when the second housing 220 is rotated in a first rotation direction (e.g., the arrow \textcircled{1} direction or the counterclockwise direction of FIGS. 7A and 7B) that is a direction in which the second housing 220 is opened with respect to the first housing 210, the first gear 241 may be rotated in the first rotation direction, and the second gear 242 may be rotated in a second rotation direction (e.g., the arrow \textcircled{2}direction or the clockwise direction of FIGS. 7A and 7B) that is opposite to the first rotation direction. In this case, the third gear 243 may be rotated in the first rotation direction (e.g., the arrow \textcircled{1} direction or the counterclockwise direction of FIGS. 7A and 7B), and the fourth gear 244 may be rotated in the second rotation direction (e.g., the arrow \textcircled{2} direction or the clockwise direction of FIGS. 7A and 7B). When the fourth gear 244 is rotated in the second rotation direction (e.g., the arrow \textcircled{2} direction or the clockwise direction of FIGS. 7A and 7B), the first hinge cover 271 may be inclined to form an obtuse angle with respect to the first housing 210 (see FIGS. 9C to 9F), and the first connection link 264 fixed to the first hinge cover 271 may move together with the first hinge cover 271. In this case, the first link 261 may be moved away from the first connection link 264 and the first hinge cover 271 or closer to the second hinge structure 250. For example, the first link 261 may be moved in a third rotation direction (e.g., the arrow \textcircled{a} direction or the clockwise direction of FIG. 7A). Referring to FIG. 7B, as the first link shaft 261a connected to the first link 261 slides in the guide recess 213, the first link 261 may be moved in the third rotation direction (e.g., the arrow \textcircled{a} direction or the clockwise direction of FIG. 7A). For example, the intermediate link 263 connected to the first link shaft 261a may be rotated in the third rotation direction (e.g., the arrow \textcircled{a} direction or the clockwise direction of FIG. 7A) based on the movement of the first link 261. In this case, the second link shaft 262a connected to the intermediate link 263 may be moved in the third rotation direction (e.g., the arrow \textcircled{a} direction or the clockwise direction of FIG. 7A). The second link 262 may be moved together with the intermediate link 263 in the third rotation direction (e.g., the arrow \textcircled{a} direction or the clockwise direction of FIGS. 9A and 9B) by the rotation of the intermediate link 263. For example, the second link 262 may be moved away from the second hinge cover 272 or closer to the first hinge structure 240. The gear array 251 of the second hinge structure 250 may be rotated based on the movement of the second link 262, and may be rotated in the second rotation direction (e.g., the arrow \textcircled{2} direction or the clockwise direction of FIGS. 7A and 7B), which is the direction in which the third housing 230 is opened with respect to the first housing 210 or the third housing 230. For example, the third rotation direction (e.g., arrow \textcircled{a} direction of FIGS. 7A and 7B) and the second rotation direction (e.g., arrow \textcircled{2}direction of FIGS. 7A and 7B) may refer to substantially the same direction (e.g., clockwise or counterclockwise).

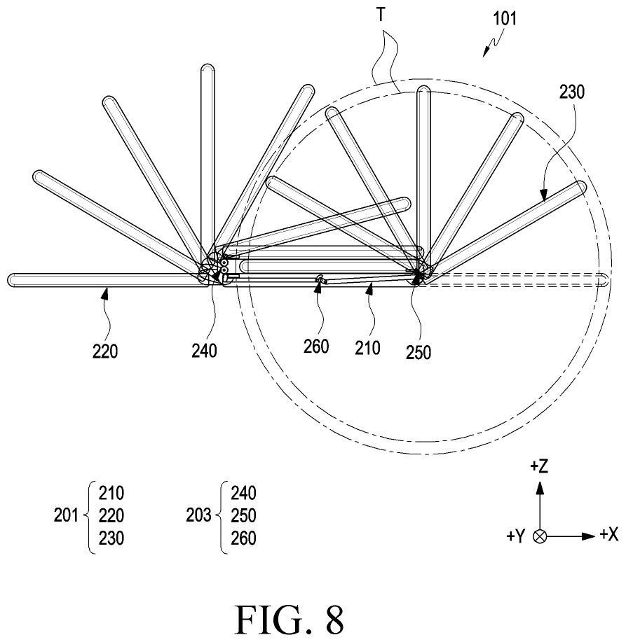

FIG. 8 is a view illustrating a rotation operation of a housing of an electronic device according to an embodiment of the disclosure. FIGS. 9A to 9F are side views illustrating an electronic device in an intermediate state according to various embodiments of the disclosure. FIG. 9G is a side view illustrating an electronic device in a folded state according to an embodiment of the disclosure.

The electronic device 101 of FIGS. 8 and 9A to 9G may be referred to as the electronic device 101 of FIGS. 5, 6, 7A, and 7B.

The dashed line T of FIG. 8 may represent the rotational trajectory of the third housing 230 viewed from one side surface. According to an embodiment, the width of the second housing 220 and the width of the third housing 230 may be set so that the second housing 220 and the third housing 230 do not interfere with each other when the second housing 220 and the third housing 230 rotate at the same time. Here, the width of the second housing 220 or the third housing 230 may refer to the length of the second housing 220 or the third housing 230 in the X-axis direction with respect to the folded state of the electronic device 101 (see FIG. 7A). Referring to FIG. 8, in an embodiment, the width of the third housing 230 may be shorter than the width of the second housing 220. The radius of rotation of the second housing 220 may be larger than the radius of rotation of the third housing 230. In the disclosure, the width of the second housing 220 and the width of the third housing 230 may be changed. For example, when the third housing 230 is rotated based on the rotation of the second housing 220, the width of the second housing 220 and the width of the third housing 230 may be changed according to a parameter such as the difference between the times when the two housings 220 and 230 start to rotate or the rotational speeds of the two housings 220 and 230.

FIGS. 9A to 9F may illustrate the intermediate state between the folded state (see FIG. 7A) and the unfolded state (see FIG. 9G) of the electronic device 101.

Referring to FIGS. 9A to 9F, when the second housing 220 is rotated in a direction in which the second housing 220 is unfolded or opened with respect to the first housing 210 (e.g., the direction of arrow \textcircled{1} or the counterclockwise direction of FIGS. 9A and 9B), the rotation link structure 260 may operate so that the third housing 230 may be unfolded or opened with respect to the first housing 210 in conjunction with the rotation of the second housing 220. When the state of FIG. 9A is sequentially changed to the state of FIG. 9F, rotation may be performed so that the angle α formed by the second housing 220 with respect to the first housing 210 gradually increases, and the first link 261 may be moved in a direction away from the first hinge cover 271 or in a direction closer to the second hinge structure 250 (e.g., direction \textcircled{3} of arrows in FIGS. 9A and 9B). Based on the movement of the first link 261, the intermediate link 263 of the rotation link structure 260 may be rotated in the third rotation direction (e.g., the arrow \textcircled{a} direction or the clockwise direction of FIGS. 9A and 9B). In this case, the third link shaft 263a may slide in the third rotation direction (e.g., the arrow \textcircled{a} direction or the clockwise direction of FIGS. 9A and 9B) in the guide recess 213. The second link 262 may move together with the intermediate link 263 in the third rotation direction (e.g., the arrow \textcircled{a} direction or the clockwise direction of FIGS. 9A and 9B) by the rotation of the intermediate link 263. For example, the second link 262 may be moved away from the second hinge cover 272 or closer to the first hinge structure 240. The gear array (e.g., the gear array 251 of FIG. 7A) of the second hinge structure 250 may be rotated based on the movement of the second link 262, and the third housing 230 may be rotated in a direction (e.g., the direction of arrow \textcircled{2} or the clockwise direction of FIGS. 9A and 9B) in which the third housing 230 is unfolded or opened with respect to the first housing 210 in conjunction with the rotation of the second housing 220.

FIG. 9A may illustrate a state in which the second housing 220 of the electronic device 101 according to an embodiment is rotated by a first designated angle from the folded state (see FIG. 7A) of the electronic device 101. In other words, FIG. 9A may illustrate a state in which the angle α formed by the second housing 220 with respect to the first housing 210 is rotated to be a first designated angle α₁. According to an embodiment, when the angular range in which the second housing 220 rotates from the folded state (see FIG. 7A) of the electronic device 101 or the angular range formed by the second housing 220 with respect to the first housing 210 exceeds 0 and is equal to or less than the first designated angle α₁, a portion of the second gear 242 of the first hinge structure (e.g., the first hinge structure 240 of FIG. 7B) may face the first gear area 241a in which no teeth of the first gear 241 are formed. Accordingly, the rotational force of the first gear 241 may not be transferred to the remaining components of the first hinge structure 240 including the second gear 242. Since the rotational force of the first gear 241 is not transferred to the remaining components of the first hinge structure 240, the third housing 230 interworking with the second housing 220 through a hinge assembly (e.g., the hinge assembly 203 of FIG. 6) may remain stationary. As the first gear 241 faces the first gear area 241a in which no teeth are formed, e.g., the first designated angle α₁ may be about 20 degrees to about 40 degrees or about 25 degrees to about 35 degrees, e.g., about 30 degrees. According to an embodiment, while the second housing 220 is rotated by the first designated angle α₁ from the folded state (see FIG. 7A) of the electronic device 101, the third housing 230 may remain stationary, thereby preventing interference due to rotation of the second housing 220 and the third housing 230.

FIGS. 9B and 9C may illustrate a state in which the second housing 220 of the electronic device 101 according to an embodiment is rotated by an angle larger than a first designated angle (e.g., the first designated angle α₁ of FIG. 9A) from the folded state (see FIG. 7A) of the electronic device 101. In other words, FIGS. 9B and 9C may illustrate a state in which the angle α formed by the second housing 220 with respect to the first housing 210 is rotated so that the angle α is larger than the first designated angle. According to an embodiment, when rotation is performed so that the angle α formed by the second housing 220 with respect to the first housing 210 is an angle larger than the first designated angle (e.g., the first designated angle α1 or about 30 degrees in FIG. 9A), the second housing 220 may be rotated with respect to the first housing 210. For example, the angle α formed by the second housing 220 of FIG. 9B with respect to the first housing 210 may be about 45 degrees. For example, the angle α formed by the second housing 220 of FIG. 9C with respect to the first housing 210 may be about 60 degrees. Referring to FIGS. 9A and 9C, according to an embodiment, while rotation is performed so that the angle α formed by the second housing 220 with respect to the first housing 210 changes from a first designated angle (e.g., the first designated angle α₁ or about 30 degrees in FIG. 9A) to about 60 degrees, the angle (or distance) by which the third housing 230 rotates with respect to the first housing 210 may be larger than the angle (or distance) by which the second housing 220 rotates with respect to the first housing 210. In this case, in FIG. 9B, i.e., the angle β formed by the third housing 230 with respect to the first housing 210 may be larger than a first designated angle (e.g., the first designated angle α₁ or about 30 degrees in FIG. 9A). In other words, when the angle α formed by the second housing 220 with respect to the first housing 210 is rotated in a range larger than or equal to a first designated angle (e.g., the first designated angle α₁ or about 30 degrees in FIG. 9A) and less than about 60 degrees, the rotational speed of the third housing 230 may be larger than the rotational speed of the second housing 220. For example, the rotational speed of the third housing 230 may be adjusted by parameters such as the number and diameters of gears of the gear array 251 (e.g., the gear array 251 of FIG. 7A) of the second hinge structure 250, the number of teeth of the gears, and the shape of the intermediate link 263 of the rotation link structure 260.

FIGS. 9D, 9E, and 9F may illustrate a state in which an angle formed by the second housing 220 of the electronic device 101 with the first housing 210 according to an embodiment is rotated to be larger than a first designated angle (e.g., the first designated angle α₁ of FIG. 9A). For example, the angle α formed by the second housing 220 of FIG. 9D with respect to the first housing 210 may be about 90 degrees. For example, the angle α formed by the second housing 220 of FIG. 9E with respect to the first housing 210 may be about 120 degrees. For example, the angle α formed by the second housing 220 of FIG. 9F with respect to the first housing 210 may be about 150 degrees. Referring to FIG. 9D, in an embodiment, when rotation is performed so that the angle α formed by the second housing 220 with respect to the first housing 210 is within a range larger than or equal to a first designated angle (e.g., the first designated angle α₁ or about 30 degrees in FIG. 9A) and less than a second designated angle, the rotational speed of the third housing 230 may be larger than the rotational speed of the second housing 220. Referring to FIG. 9D, e.g., when rotation is performed so that the angle α formed by the second housing 220 with respect to the first housing 210 is within a range larger than or equal to a first designated angle (e.g., the first designated angle α₁ or about 30 degrees in FIG. 9A) and less than a second designated angle, the angle β formed by the third housing 230 with respect to the first housing 210 may be smaller than the angle α formed by the second housing 220 with respect to the first housing 210. Referring to FIGS. 9E and 9F, according to an embodiment, when rotation is performed so that the angle α formed by the second housing 220 with respect to the first housing 210 is within a range exceeding the second designated angle, the rotational speed of the third housing 230 may be substantially the same as the rotational speed of the second housing 220. Referring to FIGS. 9E and 9F, e.g., when rotation is performed so that the angle α formed by the second housing 220 with respect to the first housing 210 is within a range exceeding the second designated angle, the angle β formed by the third housing 230 with respect to the first housing 210 may be substantially the same as or similar to the angle α formed by the second housing 220 with respect to the first housing 210. For example, the second designated angle may be larger than or equal to about 90 degrees and less than or equal to about 120 degrees.

FIG. 9G illustrates an unfolded state or an open state of the electronic device 101 according to an embodiment of the disclosure. According to an embodiment, when the electronic device 101 is in the unfolded state, the angle α formed by the second housing 220 with respect to the first housing 210 and the angle β formed by the third housing 230 with respect to the first housing 210 may be substantially the same, and may be, e.g., a third designated angle. For example, the third designated angle may be about 180 degrees and may have an error within about 10 degrees. According to an embodiment, when the electronic device 101 is in the unfolded state illustrated in FIG. 9G, the second housing 220 and the third housing 230 may substantially simultaneously form the third designated angle (e.g., about 180 degrees) with respect to the first housing 210. According to an embodiment, the second housing 220 and the third housing 230 may be rotated to form an angle exceeding about 180 degrees with respect to the first housing 210.

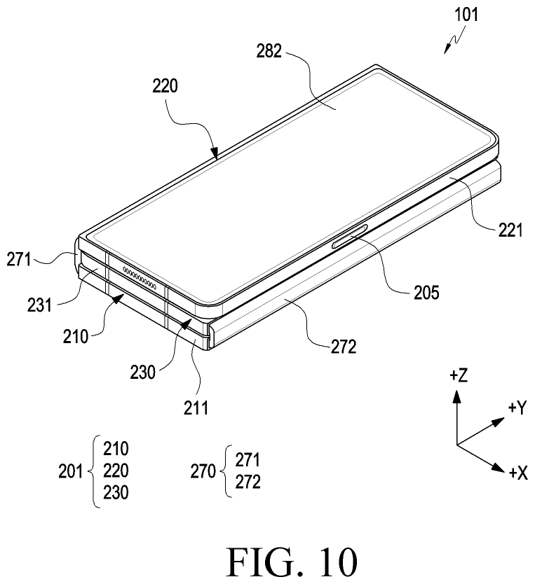

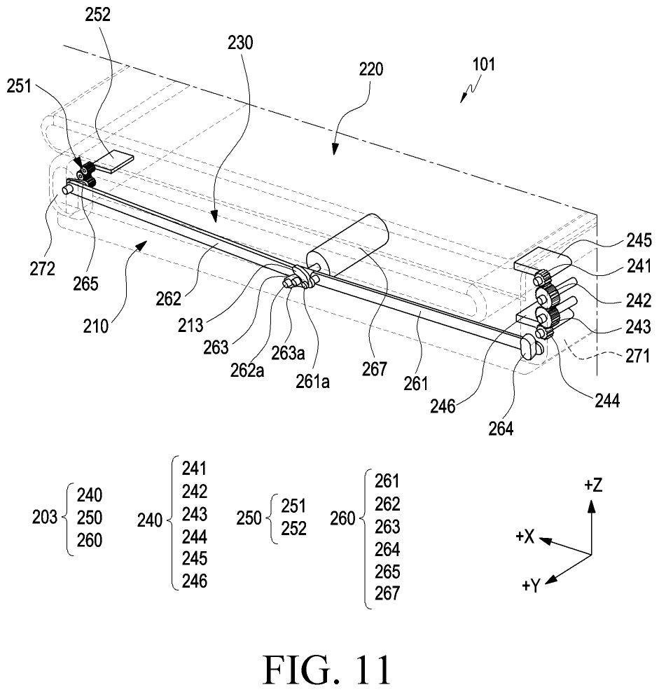

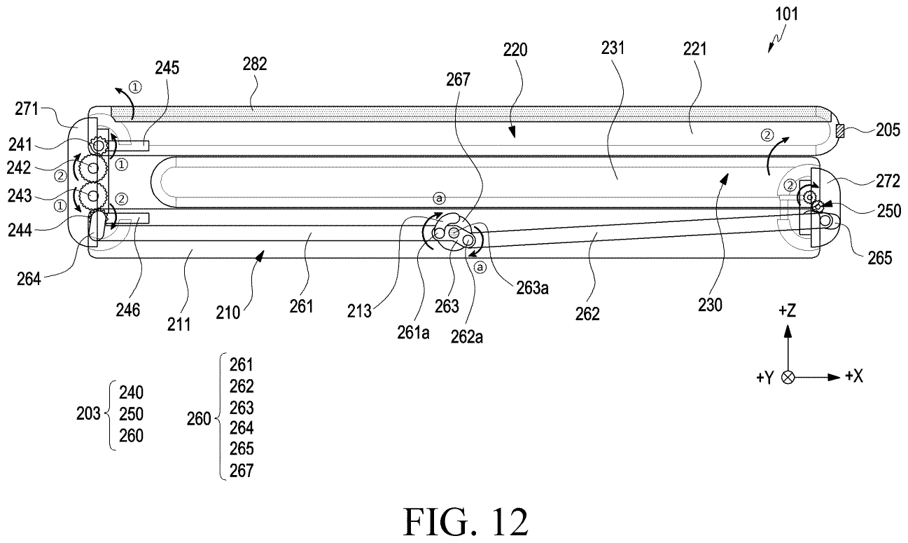

FIG. 10 is a perspective view illustrating an electronic device according to an embodiment of the disclosure. FIG. 11 is a perspective view illustrating a hinge assembly of an electronic device according to an embodiment of the disclosure. FIG. 12 is a side view illustrating an electronic device in a folded state according to an embodiment of the disclosure.

The configuration of the electronic device 101 of FIGS. 10 and 11 may be the same in whole or part as the configuration of the electronic device 101 of the embodiments of FIGS. 5, 6, 7A, 7B, 8, and 9A to 9G. The housing 201 of FIG. 10 may be referred to as the housing 201 of FIGS. 5 and 8. The hinge assembly 203 of FIG. 11 may be referred to as the hinge assembly 203 of FIGS. 5, 6, 7A, and 8.

In the embodiments of FIGS. 10 to 12, as compared to the embodiments of FIGS. 5, 6, 7A, 7B, 8, and 9A to 9G, the rotation of the second housing 220 and/or the third housing 230 with respect to the first housing 210 may be implemented not only manually but also automatically. According to an embodiment, as is described below, the electronic device 101 according to the embodiments of FIGS. 10 to 12 may automate the rotation of the second housing 220 and/or the third housing 230 by adding a button (e.g., the button 205 of FIG. 10) and/or a motor (e.g., the motor 267 of FIG. 11) to the electronic device 101 according to the embodiments of FIGS. 5, 6, 7A, 7B, 8, and 9A to 9G. The embodiments of FIGS. 5, 6, 7A, 7B, 8, and 9A to 9G do not conflict with the embodiments of FIGS. 10 to 12, and the description of the embodiments of FIGS. 5, 6, 7A, 7B, 8, and 9A to 9G may be identically or similarly applied to the embodiments of FIGS. 10 to 12. Hereinafter, for the components assigned the same reference numerals, the above description made with reference to FIGS. 5, 6, 7A, 7B, 8, and 9A to 9G is not repeated below.

Referring to FIG. 10, in an embodiment, the electronic device 101 may include a button 205 disposed on a portion of the housing 201. According to an embodiment, the button 205 may be configured to detect a user input (e.g., touch or press) to change the electronic device 101 between the folded state (see FIGS. 10 to 12) and the unfolded state (see FIG. 9G). According to an embodiment, the button 205 may be disposed on the second side structure of the second housing 220. In the disclosure, the shape and placement of the button 205 may be changed. For example, the button 205 may be disposed on the first side structure 211 of the first housing 210, the third side structure or the third rear cover 283 of the third housing 230, or the first rear cover (e.g., the first rear cover 281 of FIG. 3). According to an embodiment, the button 205 may be implemented as a touch button rather than a mechanical button, and may not be visually exposed to the exterior of the electronic device 101. For example, a sub display may be disposed in at least a partial area of the second rear cover 282, and a button for changing the electronic device 101 between the folded state and the unfolded state by detecting a user input (e.g., touch or press) may be implemented in a partial area of the sub display.

Referring to FIG. 11, in an embodiment, the rotation link structure 260 may further include a motor 267. According to an embodiment, the motor 267 may provide power for rotating the second housing 220 and the third housing 230 with respect to the first housing 210. The motor 267 may be connected to the intermediate link 263 through the third link shaft 263a. The third link shaft 263a may be fixedly connected to the intermediate link 263 and the motor 267.

Hereinafter, operations of the second housing 220, the third housing 230, the first hinge structure 240, the second hinge structure 250, and the rotation link structure 260 when the electronic device 101 is changed from the folded state to the unfolded state are described with reference to FIG. 12. When a user input (e.g., touch or press) is detected on the button 205 of FIG. 10, the motor 267 may be driven to rotate the third link shaft 263a. When the motor 267 is driven, the intermediate link 263 connected to the third link shaft 263a may be rotated in the third rotation direction (e.g., the arrow \textcircled{a} direction or the clockwise direction of FIG. 12). The first link shaft 261a and the second link shaft 262a may move together with the intermediate link 263 in the third rotation direction (e.g., the arrow \textcircled{a} direction or the clockwise direction of FIG. 12). In this case, the first link shaft 261a may slide in the third rotation direction (e.g., the arrow \textcircled{a} direction or the clockwise direction of FIGS. 9A and 9B) in the guide recess 213. Due to the movement of the first link shaft 261a, the first link 261 may be moved in the third rotation direction (e.g., the arrow \textcircled{a} direction or the clockwise direction of FIG. 12). For example, the first link 261 may be moved closer to the first hinge structure 240. Due to the movement of the second link shaft 262a, the second link 262 may be moved in the third rotation direction (e.g., the arrow \textcircled{a} direction or the clockwise direction of FIG. 12). For example, the second link 262 may be moved away from the second hinge cover 272 or closer to the first hinge structure 240.

According to an embodiment, based on the movement of the first link 261, the first hinge cover 271 fixed to the first connection link 264 may be inclined to form an obtuse angle with respect to the first housing 210 (see FIGS. 9C to 9F), and the fourth gear 244 may be rotated in the second rotation direction (e.g., the arrow direction \textcircled{2} or the clockwise direction of FIGS. 7A and 7B). The rotational force of the fourth gear 244 may be transferred to the first gear 241 via the third gear 243 and the second gear 242, and the first gear 241 may be rotated in the first rotation direction (e.g., the arrow \textcircled{1} direction or the counterclockwise direction of FIG. 12). Accordingly, the second housing 220 connected to the first gear 241 by the first fixing member 245 may be rotated in a first rotation direction in which it is opened with respect to the first housing 210. When the second link 262 approaches the first hinge structure 240 (e.g., direction 3 of the arrow of FIG. 12), the gear array 251 of the second hinge structure 250 may be rotated, and the third housing 230 may be rotated in the second rotation direction (e.g., direction \textcircled{2} of the arrow of FIG. 12 or clockwise), which is a direction in which the third housing 230 is opened with respect to the first housing 210 or the third housing 230. The electronic device 101 of FIGS. 10 to 12 may be changed between a manually folded state (or a closed state) and an unfolded state (or an open state) as described above with reference to FIGS. 7A and 9A to 9G. For example, by manually rotating the second housing 220 in the direction in which the second housing 220 is opened or closed with respect to the first housing 210, the second housing 220 and the third housing 230 interworking therewith may be rotated with respect to the first housing 210, and the electronic device 101 may be changed between the folded state (or the closed state) and the unfolded state (or the open state).

In general, a multi-foldable electronic device may have a structure of requiring that the user unfold or fold each of the second housing and the third housing rotatably connected to the first housing, and such a structure may be cumbersome to operate as compared to an electronic device having a bar structure or a foldable structure in which two housings are superimposed.

Aspects of the disclosure are to address at least the above-described problems and/or disadvantages, and to provide at least the advantages described below.

According to an embodiment of the disclosure, there may be a multi-foldable electronic device. The multi-foldable electronic device may include a second housing and a third housing connected to two opposite sides of a first housing and be configured to allow the third housing interworking with the second housing to be unfolded or folded without additional manipulation when the user manually or automatically unfolds or folds the second housing on the first housing. According to an embodiment of the disclosure, it is possible to allow the second housing and the third housing to be unfolded or folded simultaneously on the first housing by manipulating only one of the second housing or the third housing without the need for unfolding or folding each of the second housing and the third housing rotatably connected to the first housing.

The disclosure is not limited to the foregoing embodiments but various modifications or changes may rather be made thereto without departing from the spirit and scope of the disclosure. The effects that may be obtained from this disclosure are not limited to the effects mentioned above, and various effects that may be directly or indirectly identified through the disclosure may be provided.

It is apparent to one of ordinary skill in the art that the hinge assembly and the electronic device including the hinge assembly of the disclosure as described above are not limited to the above-described embodiments and those shown in the drawings, and various changes, modifications, or alterations may be made thereto without departing from the scope of the disclosure.

According to an embodiment of the disclosure, an electronic device 101 may be provided. The electronic device may comprise a first housing 210, a second housing 220, a third housing 230, and a hinge assembly 203. The hinge assembly may comprise a first hinge structure 240 rotatably connecting the second housing to the first housing, a second hinge structure 250 rotatably connecting the third housing to the first housing, and a rotation link structure 260. The rotation link structure may include a first link 261 rotatably connected to the first hinge structure, a second link 262 rotatably connected to the second hinge structure, and an intermediate link 263 connected to one end portion of the first link and one end portion of the second link and configured to be rotatable about a rotation axis. When the first housing is rotated, the third housing may be rotated according to the movement of the first link and the second link. According to an embodiment, the electronic device may be changeable between a folded state in which the first housing and the second housing are disposed to face each other with the third housing interposed therebetween, and an unfolded state in which the third housing is disposed between the first housing and the second housing.

According to an embodiment, the hinge assembly may be configured such that when an inclination angle of the second housing with respect to the first housing becomes greater than a first designated angle α₁ while the second housing rotates, the third housing starts to rotate based on the rotation of the second housing.

According to an embodiment, when the inclination angle of the second housing with respect to the first housing is less than or equal to the first designated angle while the second housing rotates, the third housing may maintain a stationary state.

According to an embodiment, the first hinge structure may include a first gear 241 connected to the second housing, a second gear 242 meshed with the first gear, a third gear 243 meshed with the second gear, and a fourth gear 244 meshed with the third gear and connected to the first housing.

According to an embodiment, the first gear 241 may include a first gear area 241a in which no teeth may be formed. A portion of the third gear may face the first gear area of the first gear when an inclination angle of the second housing with respect to the first housing may be less than or equal to a first designated angle.

According to an embodiment, the first gear may include a second gear area 241b disposed around the first gear area and in which teeth may be formed. The third gear may mesh with the second gear area of the first gear when an inclination angle of the second housing with respect to the first housing may be greater than the first designated angle.

According to an embodiment, a first hinge cover 271 surrounding at least a portion of the first hinge structure. According to an embodiment, the rotation link structure may include a first connection link 264 rotatably connected to the first hinge structure and fixedly connected to the first hinge cover.

According to an embodiment, the intermediate link may include a first portion to which the first link is rotatably connected and a second portion to which the second link is rotatably connected and inclined with respect to the first portion.

According to an embodiment, the rotation link structure may further comprise a first link shaft 261a connecting the first link and the intermediate link. The first housing may comprise a guide recess 213 formed to accommodate a portion of the first link shaft.

According to an embodiment, the guide recess may be configured to limit an angular range in which the intermediate link is rotated around the rotation axis.

According to an embodiment, when the inclination angle of the second housing with respect to the first housing is less than or equal to the first designated angle while the second housing rotates, the intermediate link may maintain a stationary state. When the inclination angle of the second housing with respect to the first housing becomes greater than the first designated angle while the second housing rotates, the intermediate link may be rotated with respect to the rotation axis.

According to an embodiment, an inclination angle of the second housing with respect to the first housing is greater than the first designated angle and is a second designated angle or less, an inclination angle of the third housing with respect to the first housing may be smaller than the inclination angle of the second housing with respect to the first housing.

According to an embodiment, each of the second housing and the third housing may be configured to form a third designated angle α₃ with respect to the first housing when the electronic device is in the unfolded state.

According to an embodiment, the first housing may include a first front surface 210a facing the third housing in the folded state of the electronic device. The second housing may include a second front surface 220a facing in a direction parallel to a direction in which the first front surface faces in the unfolded state of the electronic device. The third housing may include a third front surface 230a facing in a direction parallel to the direction in which the first front surface faces when the electronic device is in the unfolded state.

According to an embodiment, the electronic device may further comprise a flexible display 202 disposed across the first front surface, the second front surface, and the third front surface.

According to an embodiment, the guide recess is configured to limit the angular range to between about 30 degrees to about 60 degrees.

According to an embodiment, the guide recess is configured to limit the angular range to approximately 45 degrees.

According to an embodiment of the disclosure, an electronic device 101 may be provided. The electronic device may comprise a first housing 210, a second housing 220, a third housing 230, and a hinge assembly 203. The hinge assembly may comprise a first hinge structure 240 rotatably connecting the second housing to the first housing, a second hinge structure 250 rotatably connecting the third housing to the first housing, and a rotation link structure 260. The rotation link structure may include a first link 261 rotatably connected to the first hinge structure, a second link 262 rotatably connected to the second hinge structure, and an intermediate link 263 connected to one end portion of the first link and one end portion of the second link and configured to be rotatable about a rotation axis. When the first housing is rotated, the first link and the second link of the rotation link structure may be rotated to rotate the third housing. The hinge assembly may be configured such that when an inclination angle of the second housing with respect to the first housing becomes greater than a first designated angle α₁ while the second housing rotates, the third housing starts to rotate based on the rotation of the second housing.

According to an embodiment, the intermediate link may include a first portion to which the first link is rotatably connected and a second portion to which the second link is rotatably connected and inclined with respect to the first portion.

According to an embodiment, the rotation link structure may further comprise a first link shaft 261a connecting the first link and the intermediate link. The first housing may comprise a guide recess 213 formed to accommodate a portion of the first link shaft.

According to an embodiment, the electronic device may be changeable between a folded state in which the first housing and the second housing are disposed to face each other with the third housing interposed therebetween, and an unfolded state in which the third housing is disposed between the first housing and the second housing.

According to an embodiment, when the inclination angle of the second housing with respect to the first housing is less than or equal to the first designated angle while the second housing rotates, the intermediate link may maintain a stationary state.

While the disclosure has been described and shown in connection with an embodiment, it should be appreciated that an embodiment is intended as limiting the disclosure but as illustrative. It will be apparent to one of ordinary skill in the art that various changes may be made in form and detail without departing from the overall scope of the disclosure, including the appended claims and their equivalents.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the scope of the disclosure as defined by the appended claims and their equivalents.

What is claimed is:

1. An electronic device comprising:
a first housing, a second housing, a third housing, and a hinge assembly,
wherein the hinge assembly comprises:
a first hinge structure rotatably connecting the second housing to the first housing,
a second hinge structure rotatably connecting the third housing to the first housing, and
a rotation link structure including a first link having one end connected to the first hinge structure, a second link having one end connected to the second hinge structure, and an intermediate link configured to rotate about a rotation axis,
wherein the other end of the first link and the other end of the second link are connected to the intermediate link, and
wherein in response to the first housing being rotated, the third housing is configured to be rotated according to a movement of the first link and the second link.

2. The electronic device of claim 1, wherein the hinge assembly is configured such that when an inclination angle of the second housing with respect to the first housing becomes greater than a first designated angle (α1) while the second housing rotates, the third housing starts to rotate based on the rotation of the second housing.

3. The electronic device of claim 2, wherein the first hinge structure includes a first gear connected to the second housing, a second gear meshed with the first gear, a third gear meshed with the second gear, and a fourth gear meshed with the third gear and connected to the first housing.

4. The electronic device of claim 3,
wherein the first gear includes a first gear area in which no teeth are formed, and
wherein a portion of the third gear faces the first gear area of the first gear when an inclination angle of the second housing with respect to the first housing is less than or equal to a first designated angle.

5. The electronic device of claim 4,
wherein the first gear includes a second gear area disposed around the first gear area and in which teeth are formed, and
wherein the third gear meshes with the second gear area of the first gear when an inclination angle of the second housing with respect to the first housing is greater than the first designated angle.

6. The electronic device of claim 1, further comprising:
a first hinge cover surrounding at least a portion of the first hinge structure,
wherein the rotation link structure includes a first connection link rotatably connected to the first hinge structure and fixedly connected to the first hinge cover.

7. The electronic device of claim 1, wherein the intermediate link includes a first portion to which the other end of the first link is connected and a second portion to which the other end of the second link is connected and inclined with respect to the first portion.

8. The electronic device of claim 1,
wherein the rotation link structure further comprises a first link shaft connecting the first link and the intermediate link, and
wherein the first housing comprises a guide recess configured to accommodate a portion of the first link shaft.

9. The electronic device of claim 8, wherein the guide recess is configured to limit an angular range in which the intermediate link is rotated around the rotation axis.

10. The electronic device of claim 9, wherein the guide recess is configured to limit the angular range to between 30 degrees to 60 degrees.

11. The electronic device of claim 9, wherein the guide recess is configured to limit the angular range to approximately 45 degrees.

12. The electronic device of claim 2,
wherein the electronic device is configured such that when the inclination angle of the second housing with respect to the first housing is less than or equal to the first designated angle while the second housing rotates, the intermediate link maintains a stationary state, and
wherein, when the inclination angle of the second housing with respect to the first housing becomes greater than the first designated angle while the second housing rotates, the intermediate link is rotated with respect to the rotation axis.

13. The electronic device of claim 12, wherein an inclination angle of the second housing with respect to the first housing is greater than the first designated angle and is a second designated angle or less, an inclination angle of the third housing with respect to the first housing is smaller than the inclination angle of the second housing with respect to the first housing.

14. The electronic device of claim 1, wherein the electronic device is changeable between a folded state in which the first housing and the second housing are disposed to face each other with the third housing interposed therebetween, and an unfolded state in which the third housing is disposed between the first housing and the second housing.

15. The electronic device of claim 14, wherein each of the second housing and the third housing is configured to form a third designated angle (α3) with respect to the first housing when the electronic device is in the unfolded state.

16. The electronic device claim 14,
wherein the first housing includes a first front surface facing the third housing in the folded state of the electronic device,
wherein the second housing includes a second front surface facing in a direction parallel to a direction in which the first front surface faces in the unfolded state of the electronic device, and
wherein the third housing includes a third front surface facing in a direction parallel to the direction in which the first front surface faces when the electronic device is in the unfolded state.

17. The electronic device of claim 16, further comprising:
a flexible display disposed across the first front surface, the second front surface, and the third front surface.

18. An electronic device comprising:
a first housing, a second housing, a third housing, and a hinge assembly,
wherein the hinge assembly comprises:
a first hinge structure rotatably connecting the second housing to the first housing,
a second hinge structure rotatably connecting the third housing to the first housing, and
a rotation link structure including a first link having one end connected to the first hinge structure, a second link having one end connected to the second hinge structure, and an intermediate link configured to rotate about a rotation axis,
wherein the other end of the first link and the other end of the second link are connected to the intermediate link,
wherein when the first housing is rotated, the first link and the second link of the rotation link structure are configured to be rotated to rotate the third housing, and
wherein the hinge assembly is configured such that when an inclination angle of the second housing with respect to the first housing becomes greater than a first designated angle α1 while the second housing rotates, the third housing starts to rotate based on the rotation of the second housing.

19. The electronic device of claim 18, wherein the intermediate link includes a first portion to which the other end of the first link is connected and a second portion to which the other end of the second link is connected and inclined with respect to the first portion.

20. The electronic device of claim 18,
wherein the rotation link structure further comprises a first link shaft connecting the first link and the intermediate link, and
wherein the first housing comprises a guide recess configured to accommodate a portion of the first link shaft.
